(19) United States
(12) Patent Application Publication
(10) Pub. No.: US 2025/0016017 A1
(43) Pub. Date: Jan. 9, 2025

(54) OPTIMIZED SRv6 MULTICASTING FOR NETWORK ASSISTED PUBLISH-SUBSCRIBE SYSTEMS

(71) Applicant: Nokia Solutions and Networks Oy, Espoo (FI)

(72) Inventors: Muralidharan KODIALAM, Austin, TX (US); Fang HAO, Murray Hill, NJ (US); Hyunseok CHANG, Murray Hill, NJ (US); TV LAKSHMAN, Murray Hill, NJ (US); Sarit MUKHERJEE, Murray Hill, NJ (US); Matteo VARVELLO, Murray Hill, NJ (US)

(21) Appl. No.: 18/712,652

(22) PCT Filed: Nov. 24, 2021
(86) PCT No.: PCT/US2021/060794

§ 371 Date: May 22, 2024

(51) Int. Cl. H04L 12/18; H04L 12/44; H04L 45/00; H04L 45/16

(52) U.S. Cl. CPC H04L 12/1881; H04L 12/185; H04L 12/44; H04L 45/16; H04L 45/34

(57) ABSTRACT

In a system, apparatus, method, and non-transitory computer readable medium for implementing SRv6 multicasting for network assisted publish-subscribe systems, a source host device may be caused to, obtain multicast scheduling information from a software defined network (SDN) controller, the multicast scheduling information including information related to a plurality of multicast trees associated with a network, each multicast tree of the plurality of multicast trees including at least one network node, and transmit a plurality of multi-stream multicast transmissions associated with a source multicast stream transmission to a plurality of destination host devices using a multicast group session tree based on the multicast scheduling information, the multicast group session tree associated with a desired multicast group, the multicast group including the source host device and the plurality of destination host devices.

### BACKGROUND

### Field

Various example embodiments relate to methods, apparatuses, systems, and/or non-transitory computer readable media for providing segment routing over IPv6 (SRv6) multicasting for network assisted publish-subscribe systems.

### Description of the Related Art

With the deployment of 5^{th} generation mobile network (5G) networks and other high-speed networks, there has been increased proliferation of network-enabled devices and/or applications, such as Internet of Things (IoT) devices, autonomous devices, industrial sensors, network-enabled medical devices, streaming audio/video applications, video conferencing applications, voice-over-IP (VOIP) applications, etc. With the massive increase in the number of networked devices and sensors, there is a corresponding increase in data being transmitted over networks, particularly data requiring strict Quality of Service (QOS), such as ultra-low latency, high reliability, etc., and/or massive scaling, etc. Accordingly, a network-assisted publish-subscribe architecture has been proposed, wherein one or more destination host devices (e.g., edge devices, edge network nodes, destination nodes, etc.) “subscribe” to the multicast streams which are “published” by a source host device (e.g., source devices, source network nodes, source nodes, etc.) using the SRv6 multicasting standard.

In the SRv6 multicasting standard, multicast groups are created on desired and/or pre-defined multicast trees, and a SRv6 source host device and/or Software Defined Networking (SDN) controller controls the routing path of multicast packets (e.g., multicast streams) by embedding a segment list (e.g., a list of SRv6 addresses corresponding to intermediate network nodes of the SRv6 multicast tree) into the SRv6 header of the multicast packets, and thereby processing the complex computations and large amount of tree-related data required to enable traffic engineering and/or QoS multicast routing for the multicast transmissions, without requiring additional processing to be performed by intermediate (e.g., internal) network nodes. When the SRv6 multicast packet traverses the multicast tree network, it is forwarded to the next network node of the multicast tree along the segmented network path identified in the segment list of the packet header, and with the SRv6 address of each visited network node then being removed from the segment list. If any replication segments are encountered in the segment list, the SRv6 network node may replicate the SRv6 multicast packet based on the list of downstream paths, and forwards the replicated packets to their appropriate network paths/destinations, thereby enabling point-to-multipoint transmissions.

### SUMMARY

At least one example embodiment relates to a source host device.

In at least one example embodiment, the device may include a memory storing computer readable instructions and processing circuitry configured to execute the computer readable instructions to cause the device to, obtain multicast scheduling information from a software defined network (SDN) controller, the multicast scheduling information including information related to a plurality of multicast trees associated with a network, each multicast tree of the plurality of multicast trees including at least one network node, and transmit a plurality of multi-stream multicast transmissions associated with a source multicast stream transmission to a plurality of destination host devices using a multicast group session tree based on the multicast scheduling information, the multicast group session tree associated with a desired multicast group, the multicast group including the source host device and the plurality of destination host devices.

Some example embodiments provide that the multicast scheduling information includes transmission bandwidth information associated with each network node of the plurality of multicast trees, and tree subscription information indicating a single multicast tree of the plurality of multicast trees to which each destination host device is subscribed, the multicast group session tree includes a plurality of segmented network paths from the source host device to each destination host device of the plurality of destination host devices, and each of the plurality of segmented network paths are determined based on the transmission bandwidth information and the tree subscription information.

Some example embodiments provide that the multicast scheduling information includes the information on the multicast group session tree, the multicast group session tree determined from the plurality of multicast trees by the SDN controller based on the multicast scheduling information.

Some example embodiments provide that the device is further caused to determine the multicast group session tree from the plurality of multicast trees based on the multicast scheduling information.

Some example embodiments provide that the device is further caused to transmit the plurality of multi-stream multicast transmissions by dividing the source multicast stream transmission into B multi-stream multicast transmissions based on the multicast scheduling information, where B is an integer greater than 1.

Some example embodiments provide that the device is further caused to transmit the plurality of multi-stream multicast transmissions by transmitting each of the B multi-stream multicast transmissions to each of the plurality of destination host devices using different segmented network paths of the multicast group session tree to each of the plurality of destination host devices.

Some example embodiments provide that the transmitting each of the B multi-stream multicast transmissions to each of the plurality of destination host devices causes each of the destination host devices to, receive the B multi-stream multicast transmissions from the source host device, and restore the source multicast stream transmission from the received B multi-stream multicast transmissions.

Some example embodiments provide that the device is further caused to transmit the plurality of multi-stream multicast transmissions by, coding the B multi-stream multicast transmissions into C sub-stream transmissions using coding parameters, where C>B, and transmitting any N different sub-stream transmissions of the C sub-stream transmissions to each of the plurality of destination host devices using different segmented network paths, where N≥B and N≤C.

Some example embodiments provide that the device is further caused to receive the coding parameters from the SDN controller, the coding parameters including information indicating whether to use Fountain code coding or Raptor code coding, the value of B, and the value of C, and perform the coding of the B multi-stream multicast transmissions into the C sub-stream transmissions based on the received coding parameters.

Some example embodiments provide that the device is further caused to, determine the coding parameters, the determining including determining whether to use using Fountain code coding or Raptor code coding, determining the value of B, and determining the value of C, and perform the coding of the B multi-stream multicast transmissions into the C sub-stream transmissions based on the determined coding parameters.

Some example embodiments provide that the transmitting the N different sub-stream transmissions to each of the plurality of destination host devices causes each of the destination host devices to, receive at least B sub-streams, decode the B multi-stream multicast transmissions based on coding parameter information included in a packet header of the N sub-stream transmissions, and restore the source multicast stream transmission from the decoded B multi-stream multicast transmission.

At least one example embodiment relates to a software defined network (SDN) controller device.

In at least one example embodiment, the device may include a memory storing computer readable instructions and processing circuitry configured to execute the computer readable instructions to cause the device to, obtain topology information, link capacity information, and multicast group information related to a plurality of host devices of a network, determine multicast scheduling information associated with at least one multicast group based on the topology information, the link capacity information, and the multicast group information, the multicast scheduling information including, information related to a plurality of multicast trees associated with the network, each multicast tree of the plurality of multicast trees including at least one network node, transmission bandwidth information associated with each network node of the plurality of multicast trees, and tree subscription information indicating a single multicast tree of the plurality of multicast trees to which each host device is subscribed, and transmit at least a part of the multicast scheduling information to each of the host devices of the network.

Some example embodiments provide that the device is further caused to, for each multicast tree of the plurality of multicast trees, determine a plurality of segmented network paths between each host device of the multicast tree based on the transmission bandwidth information and the tree subscription information, and configure each network node included in the multicast tree based on the determined plurality of segmented network paths.

Some example embodiments provide that the device is further caused to, receive a multi-stream multicast transmission request from a source host device, the multi-stream request including information related to a source multicast stream transmission and the multicast group information, and determine the multicast scheduling information in response to the multi-stream multicast transmission request, the determining including determining a multicast group session tree from the plurality of multicast trees based on the information related to the source multicast stream transmission and the information indicating the desired multicast group.

Some example embodiments provide that the device is further caused to, determine a value B indicating a number of multi-stream multicast transmissions to divide the source multicast stream transmission into, where B is an integer greater than 1.

Some example embodiments provide that the device is further caused to, determine coding parameters for the source multicast stream transmission in response to the multi-stream multicast transmission request, the determining the coding parameters including, determining whether to use using Fountain code coding or Raptor code coding for the coding of the multi-stream multicast transmissions, and determine a value B indicating a number of multi-stream multicast transmissions to divide the source multicast stream transmission into, and determining a value C indicating a number of sub-stream transmission to divide the B multi-stream multicast transmission into, where B and C are integers greater than 1, and C>B.

At least one example embodiment relates to a method of operating a source host device.

In at least one example embodiment, the method may include obtaining multicast scheduling information from a software defined network (SDN) controller, the multicast scheduling information including information related to a plurality of multicast trees associated with a network, each multicast tree of the plurality of multicast trees including at least one network node, and transmitting a plurality of multi-stream multicast transmissions associated with a source multicast stream transmission to a plurality of destination host devices using a multicast group session tree based on the multicast scheduling information, the multicast group session tree associated with a desired multicast group, the multicast group including the source host device and the plurality of destination host devices.

Some example embodiments provide that the multicast scheduling information includes transmission bandwidth information associated with each network node of the plurality of multicast trees, and tree subscription information indicating a single multicast tree of the plurality of multicast trees to which each destination host device is subscribed, the multicast group session tree includes a plurality of segmented network paths from the source host device to each destination host device of the plurality of destination host devices, and each of the plurality of segmented network paths are determined based on the transmission bandwidth information and the tree subscription information.

Some example embodiments provide that the multicast scheduling information includes the information on the multicast group session tree, the multicast group session tree determined from the plurality of multicast trees by the SDN controller based on the multicast scheduling information.

Some example embodiments provide that the method may further include determining the multicast group session tree from the plurality of multicast trees based on the multicast scheduling information.

At least one example embodiment relates to a source host device.

In at least one example embodiment, the device may include means for, obtaining multicast scheduling information from a software defined network (SDN) controller, the multicast scheduling information including information related to a plurality of multicast trees associated with a network, each multicast tree of the plurality of multicast trees including at least one network node, and transmitting a plurality of multi-stream multicast transmissions associated with a source multicast stream transmission to a plurality of destination host devices using a multicast group session tree based on the multicast scheduling information, the multicast group session tree associated with a desired multicast group, the multicast group including the source host device and the plurality of destination host devices.

Some example embodiments provide that the multicast scheduling information includes transmission bandwidth information associated with each network node of the plurality of multicast trees, and tree subscription information indicating a single multicast tree of the plurality of multicast trees to which each destination host device is subscribed, the multicast group session tree includes a plurality of segmented network paths from the source host device to each destination host device of the plurality of destination host devices, and each of the plurality of segmented network paths are determined based on the transmission bandwidth information and the tree subscription information.

Some example embodiments provide that the multicast scheduling information includes the information on the multicast group session tree, the multicast group session tree determined from the plurality of multicast trees by the SDN controller based on the multicast scheduling information.

Some example embodiments provide that the device further includes means for determining the multicast group session tree from the plurality of multicast trees based on the multicast scheduling information.

Some example embodiments provide that the device further includes means for transmitting the plurality of multi-stream multicast transmissions by dividing the source multicast stream transmission into B multi-stream multicast transmissions based on the multicast scheduling information, where B is an integer greater than 1.

Some example embodiments provide that the device further includes means for transmitting the plurality of multi-stream multicast transmissions by transmitting each of the B multi-stream multicast transmissions to each of the plurality of destination host devices using different segmented network paths of the multicast group session tree to each of the plurality of destination host devices.

Some example embodiments provide that the transmitting each of the B multi-stream multicast transmissions to each of the plurality of destination host devices causes each of the destination host devices to, receive the B multi-stream multicast transmissions from the source host device, and restore the source multicast stream transmission from the received B multi-stream multicast transmissions.

Some example embodiments provide that the device further includes means for transmitting the plurality of multi-stream multicast transmissions by, coding the B multi-stream multicast transmissions into C sub-stream transmissions using coding parameters, where C>B, and transmitting any N different sub-stream transmissions of the C sub-stream transmissions to each of the plurality of destination host devices using different segmented network paths, where N≥B and N≤ C.

Some example embodiments provide that the device further includes means for receiving the coding parameters from the SDN controller, the coding parameters including information indicating whether to use Fountain code coding or Raptor code coding, the value of B, and the value of C, and performing the coding of the B multi-stream multicast transmissions into the C sub-stream transmissions based on the received coding parameters.

Some example embodiments provide that the device further includes means for, determining the coding parameters, the determining including determining whether to use using Fountain code coding or Raptor code coding, determining the value of B, and determining the value of C, and performing the coding of the B multi-stream multicast transmissions into the C sub-stream transmissions based on the determined coding parameters.

Some example embodiments provide that the transmitting the N different sub-stream transmissions to each of the plurality of destination host devices causes each of the destination host devices to, receive at least B sub-streams, decode the B multi-stream multicast transmissions based on coding parameter information included in a packet header of the N sub-stream transmissions, and restore the source multicast stream transmission from the decoded B multi-stream multicast transmission.

At least one example embodiment relates to a software defined network (SDN) controller device.

In at least one example embodiment, the device may include means for, obtaining topology information, link capacity information, and multicast group information related to a plurality of host devices of a network, determining multicast scheduling information associated with at least one multicast group based on the topology information, the link capacity information, and the multicast group information, the multicast scheduling information including, information related to a plurality of multicast trees associated with the network, each multicast tree of the plurality of multicast trees including at least one network node, transmission bandwidth information associated with each network node of the plurality of multicast trees, and tree subscription information indicating a single multicast tree of the plurality of multicast trees to which each host device is subscribed, and transmitting at least a part of the multicast scheduling information to each of the host devices of the network.

Some example embodiments provide that the device further includes means for, for each multicast tree of the plurality of multicast trees, determining a plurality of segmented network paths between each host device of the multicast tree based on the transmission bandwidth information and the tree subscription information, and configuring each network node included in the multicast tree based on the determined plurality of segmented network paths.

Some example embodiments provide that the device further includes means for, receiving a multi-stream multicast transmission request from a source host device, the multi-stream request including information related to a source multicast stream transmission and the multicast group information, and determining the multicast scheduling information in response to the multi-stream multicast transmission request, the determining including determining a multicast group session tree from the plurality of multicast trees based on the information related to the source multicast stream transmission and the information indicating the desired multicast group.

Some example embodiments provide that the device further includes means for, determining a value B indicating a number of multi-stream multicast transmissions to divide the source multicast stream transmission into, where B is an integer greater than 1.

Some example embodiments provide that the device further includes means for, determining coding parameters for the source multicast stream transmission in response to the multi-stream multicast transmission request, the determining the coding parameters including, determining whether to use using Fountain code coding or Raptor code coding for the coding of the multi-stream multicast transmissions, and determining a value B indicating a number of multi-stream multicast transmissions to divide the source multicast stream transmission into, and determining a value C indicating a number of sub-stream transmission to divide the B multi-stream multicast transmission into, where B and C are integers greater than 1, and C>B.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a multicast communication system according to at least one example embodiment;

FIG. 2 illustrates a block diagram of an example network device according to at least one example embodiment;

FIG. 3 illustrates an example multicast network according to at least one example embodiment;

FIG. 4 illustrates an example single stream multicast tree corresponding to the multicast network of FIG. 3 according to at least one example embodiment;

FIG. 5 illustrates example multi-stream multicast trees corresponding to the multicast network of FIG. 3 according to at least one example embodiment;

FIGS. 6A and 6B illustrate an example coding of multicast streams and coded multi-stream multicast trees according to some example embodiments; and

FIGS. 7 to 8 illustrate example flowcharts according to some example embodiments.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory (ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

While the various example embodiments of the present disclosure are discussed in connection with the SRv6 and/or 5G standards for the sake of clarity and convenience, the example embodiments are not limited thereto, and one of ordinary skill in the art would recognize the example embodiments may be applicable to other multicast streaming standards and/or wireless communication standards, such as the 4G standard, the 5G standard, a Wi-Fi standard, a future 6G standard, a future 7G standard, etc.

Various example embodiments are directed towards enhancements to SRv6 multicasting standard to improve the end node processing efficiency and/or improve the network efficiency of multicast transmissions along a multicast network by using multi-stream multicasting and/or coded multi-stream multicasting to increase realized network transmission rates and/or decreased network node processing, etc. However, the example embodiments are not limited thereto, and for example, the example embodiments are not limited to the SRv6 multicasting standard and/or IPv6 networks, and may further be applied to other multicasting standards and/or other segment routed networks (e.g., segmented networks, etc.), such as multiprotocol label switching (MPLS) networks, etc.

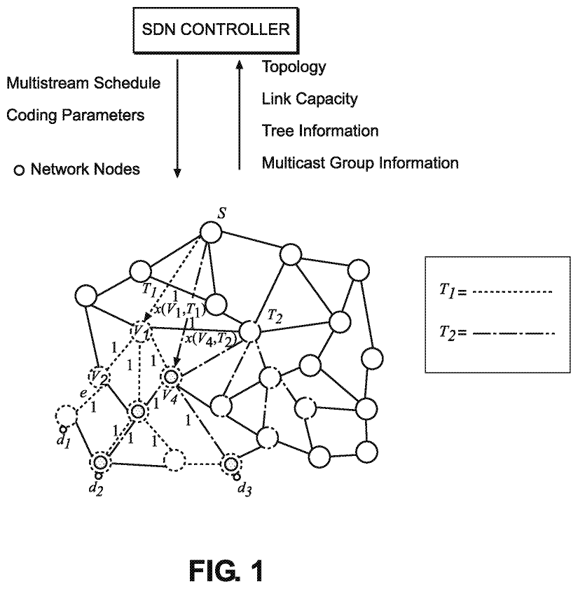

FIG. 1 illustrates a multicast communication system according to at least one example embodiment. As shown in FIG. 1, a multicast communication system includes a SDN controller 100, a source host device s, a plurality of end host devices (e.g., edge network nodes, etc.), such as a first destination host device d1, a second destination host device d2, and/or a third destination host device d3, etc., and/or a plurality of intermediate network nodes, but the example embodiments are not limited thereto. Additionally, the multicast communication system may include one or more multicast trees comprising one or more network nodes, such as multicast trees T1 and T2, but the example embodiments are not limited thereto. According to some example embodiments, the multicast communication system may include a greater or lesser number of constituent elements. For example, the wireless communication system may include a greater or lesser number of end host devices, a greater number of SDN controllers and/or may omit the SDN controller, may include a greater or lesser number of multicast trees, a greater or lesser number of network nodes, etc., additional network equipment, such as base stations, routers, access points, gateways, etc.

The SDN controller 100, source host device s, a plurality of end host devices, and/or the plurality of network nodes may be connected over a wireless network, such as a cellular wireless access network (e.g., a 3G wireless access network, a 4G-Long Term Evolution (LTE) network, a 5G-New Radio (e.g., 5G) wireless network, a 6G wireless network, a WiFi network, etc.), and/or a wired network. The wireless and/or wired network may refer to the Internet, an intranet, a wide area network, etc.

According to some example embodiments, the SDN controller 100 may be a network controller which communicates with, controls, and/or configures the end host devices s, d1, d2, and/or d3, etc., and/or the intermediate network nodes, such as network nodes v1, v2, and/or v4, etc., over the wired and/or wireless network, etc. According to at least one example embodiment, the SDN controller may be at least one network server, at least one base station, at least one access point (AP), at least one router, etc., but the example embodiments are not limited thereto. Additionally, the end host devices may be considered network nodes and vice versa, and the network nodes, e.g., s, v1, v2, v4, d1, d2, and/or d3, etc., may be network devices residing on the wired and/or wireless network and capable of receiving and/or transmitting data over the network, such as computers, servers, access points, routers, etc., but the example embodiments are not limited thereto. According to at least one example embodiment, the SDN controller 100 may transmit multicast streaming configuration information and/or configure each of the end host devices and/or the network nodes s, v1, v2, v4, d1, d2, and/or d3, etc., with the multicast streaming configuration information, etc. For example, the SDN controller 100 may receive at least one of network topology information (e.g., information related to reachable neighboring network nodes, etc., from individual nodes), link capacity information (e.g., a desired and/or maximum transmission rate between the network nodes (e.g., segments of the network), etc.), tree information (e.g., tree subscription information identifying and/or indicating a desired (e.g., pre-configured, and/or predefined, etc.) multicast tree from a plurality of pre-configured and/or predefined multicast trees selected by an end host device, etc.), multicast group information (e.g., information indicating which multicast groups a particular end host device is subscribed to and/or a member of, etc.), and/or QoS settings for a multicast transmission and/or set for the multicast group, etc., and based on the received information, the SDN controller 100 may determine one or more multicast trees for each destination end host device of the desired multicast group, such as multicast trees T1 and T2 based on current network traffic conditions, QoS demands of the multicast transmission and/or multicast group, desired (e.g., increased, optimized, and/or maximized) link capacity information, etc. Further, according to at least one example embodiment, the SDN controller 100 may also configure the network nodes, e.g., s, v1, v2, v4, d1, d2, and/or d3, etc., based on multicast configuration settings, such as multicast tree configuration information (e.g., a multicast tree configured by the SDN controller 100 based on the received information, etc.), multistream scheduling information, the type of multicast transmission to use for the multicast transmission (e.g., selecting and/or indicating at least one of a single stream multicast transmission, a multi-stream multicast transmission, a coded multi-stream multicast transmission, etc., for the multicast transmission), the number of multicast streams to divide a source multicast transmission into, the coding parameters for a multicast stream, etc., but the example embodiments are not limited thereto. Additionally, according to some example embodiments, the SDN controller 100 may be omitted from the network, and the functionality and/or operations of the SDN controller 100 may be performed by the source host device and/or other network device, etc., but the example embodiments are not limited thereto. The operations of the SDN controller 100 will be discussed in greater detail in connection with FIGS. 3 to 8.

The end host devices s, d1, d2, and/or d3, etc., may be any one of, but not limited to, a personal computer, a server, a mobile device, a smartphone, a tablet, a laptop computer, a wearable device, an Internet of Things (IoT) device, a sensor (e.g., thermometers, humidity sensors, pressure sensors, motion sensors, accelerometers, etc.), actuators, robotic devices, robotics, drones, connected medical devices, eHealth devices, smart city related devices, a security camera, autonomous devices (e.g., autonomous cars, etc.), a desktop computer and/or any other type of stationary or portable device capable of communicating over a wired and/or wireless network. The end host devices S, d1, d2, and/or d3, etc., may be configurable to transmit and/or receive data in accordance to multicast configuration settings provided by the SDN controller 100, etc., and/or in accordance to strict latency, reliability, and/or accuracy requirements, such as desired network and/or multicast QoS standards, etc., but the example embodiments are not limited thereto.

According to at least one example embodiment, the end host devices S, d1, d2, and/or d3, etc., may be members of at least one desired multicast group, and may be configured to publish and/or subscribe to multicast transmissions over the multicast group. According to at least one example embodiment, the end host device s may be a source end host device, e.g., an end host device which publishes and/or transmits a source transmission stream, etc., to end host devices which have subscribed to the end host device S, such as destination end host devices d1, d2, and/or d3, etc., but the example embodiments are not limited thereto, and for example, one or more of the destination end host devices may also be a source end host device, and/or the source end host device may be a destination end host device, etc. Additionally, according to at least one example embodiment, prior to publishing a source multicast transmission, the source end device s may transmit a multicast request to the SDN controller 100, and in response to the multicast request, the SDN controller 100 may determine and/or select segmented network routes to each of the destination host devices which have subscribed to the source end host device s, e.g., destination host devices d1, d2, and/or d3, etc., from the plurality of multicast trees included in the network and/or pre-configured for the desired multicast group. Additionally, the SDN controller 100 may determine and/or select the segmented network routes between each of the host devices without receiving a specific multicast request from an end host device, e.g., during the configuration of the multicast network, during the addition of/removal of network nodes and/or end host devices to the multicast network and/or multicast group, in response to changes in traffic conditions, link capacities, etc., in the multicast network, etc., but the example embodiments are not limited thereto.

For example, as illustrated in FIG. 1, there may be a multicast tree T1 and a multicast tree T2 which may be used to transmit the multicast transmission from the source host device s to each of the destination host devices d1 to d3 via network nodes v1, v2, v4, etc., but the example embodiments are not limited thereto. Further, as shown in FIG. 1, one or more network nodes, such as destination network nodes d2 and d3, may be included in and/or part of a plurality of multicast trees, e.g., trees T1 and T2, but the example embodiments are not limited thereto. In such an event, the network nodes, e.g., d2 and d3, and/or the SDN controller 100, may select and/or elect a single multicast tree and/or multicast segmented route to use, and the identification of the selected single multicast tree and/or multicast segmented route may be transmitted and/or stored in the memory of the SDN controller 100, etc., for use in determining the network paths and/or network routes to use in the multicast transmissions, but the example embodiments are not limited thereto. The multicast trees and/or segmented routes between host devices will be discussed in further detail in connection with FIGS. 3 to 6B.

While FIG. 1 illustrates a multicast group located on the network, the example embodiments are not limited thereto, and for example, the network may include a plurality of multicast groups, etc.

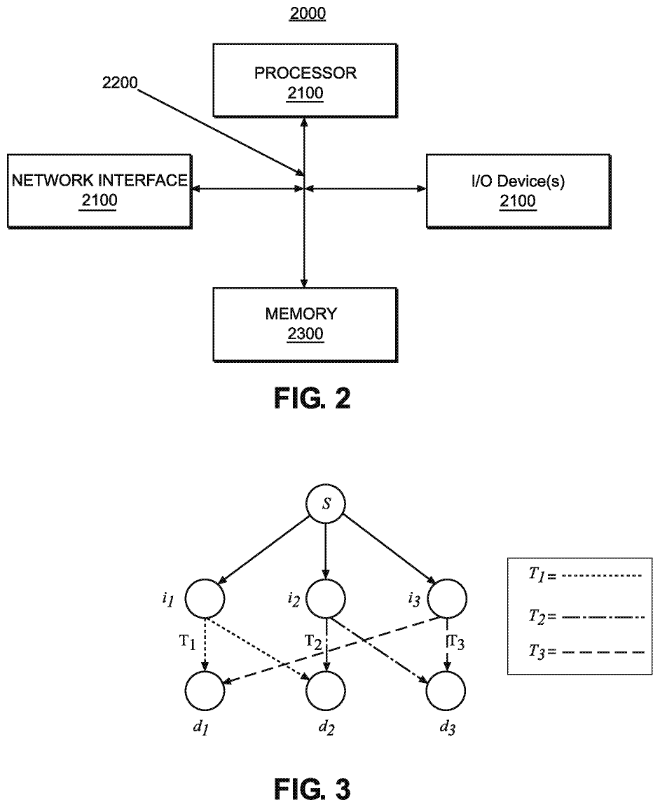

FIG. 2 illustrates a block diagram of an example network device according to at least one example embodiment. The network device of FIG. 2 may correspond to any of the SDN controller 100, end host devices S, d1, d2, and d3, and/or intermediate network nodes v1, v2, v4, etc., of FIG. 1, but the example embodiments are not limited thereto.

Referring to FIG. 2, a network device 2000 may include processing circuitry, such as at least one processor 2100, at least one communication bus 2200, a memory 2300, at least one network interface 2400, and/or at least one input/output (I/O) device 2500 (e.g., a display panel, a keyboard, a touchscreen, a mouse, a microphone, a camera, a speaker, etc.), but the example embodiments are not limited thereto, etc., but the example embodiments are not limited thereto. For example, the network device 2000 may include a plurality of wireless antenna arrays (not shown), a plurality of network interfaces, etc., a plurality of I/O devices, and/or any combinations thereof. The memory 2300 may include various special purpose program code including computer executable instructions which may cause the network device 2000 to perform the one or more of the methods of the example embodiments. Additionally, the at least one I/O device 2500 of the network device 2000 may be optional.

In at least one example embodiment, the processing circuitry may include at least one processor (and/or processor cores, distributed processors, networked processors, etc.), such as the at least one processor 2100, which may be configured to control one or more elements of the network device 2000, and thereby cause the network device 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire network device 2000. Once the special purpose program instructions are loaded into, (e.g., the at least one processor 2100, etc.), the at least one processor 2100 executes the special purpose program instructions, thereby transforming the at least one processor 2100 into a special purpose processor.

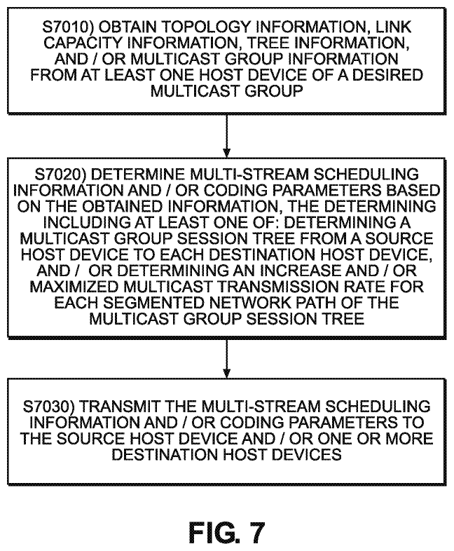

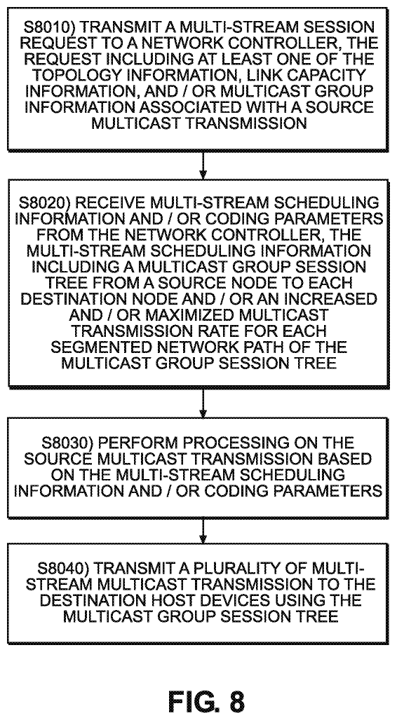

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the network device 2000, such as the methods discussed in connection with FIGS. 7 to 8, the at least one network interface 2400, and/or at least one I/O device 2500, etc. Such software elements may be loaded from a non-transitory computer-readable storage medium independent of the memory 2300, using a drive mechanism (not shown) connected to the network device 2000, or via the at least one network interface 2400, and/or at least one I/O device 2500, etc.

In at least one example embodiment, the communication bus 2200 may enable communication and data transmission to be performed between elements of the network device 2000. The bus 2200 may be implemented using a high-speed serial bus, a parallel bus, and/or any other appropriate communication technology. According to at least one example embodiment, the network device 2000 may include a plurality of communication buses (not shown), such as an address bus, a data bus, etc.

The network device 2000 may operate as, for example, a SDN controller, an end host device, a network node, etc., but the example embodiments are not limited thereto.

The network device 2000 may also include at least one network interface 2400, and/or at least one I/O device 2500, etc. The network interface 2400 may be a wired and/or wireless network interface and may enable the network device 2000 to communicate and/or transmit data to and from to network devices on the backend network, such as a core network gateway (not shown), a Data Network (e.g., Data Network 105), such as the Internet, intranets, wide area networks, telephone networks, VoIP networks, etc., as well as to network devices on the multicast network, such as the end host devices and/or network nodes S, v1, v2, v4, d1, d2, and/or d3, etc., of FIG. 1, but the example embodiments are not limited thereto.

According to at least one example embodiment, the at least one network interface 2400 may include an associated array of radio units (not shown) and may be used to transmit the wireless signals in accordance with a radio access technology, such as 4G LTE wireless signals, 5G NR wireless signals, 6G wireless signals, etc., to at least one user equipment device, such as end host devices S, d1, d2, and/or d3, etc., and/or to a core network (e.g., backend network, backhaul network, backbone network, Data Network, etc.), but the example embodiments are not limited thereto. According to some example embodiments, the I/O device 2500 may be a single antenna, or may be a plurality of antennas, etc. For example, the I/O device 2500 may be configured as a grid of beams (GoB) which transmits a plurality of beams in different directions, angles, frequencies, and/or with different delays, etc., but the example embodiments are not limited thereto. According to some example embodiments, the network interface 2400 may also be a wired network interface card, such as an Ethernet network interface card, etc., but the example embodiments are not limited thereto.

While FIG. 2 depicts an example embodiment of a network device 2000, the network device is not limited thereto, and may include additional and/or alternative architectures that may be suitable for the purposes demonstrated. For example, the functionality of the network device 2000 may be divided among a plurality of network functions located on the core network, etc., but the example embodiments are not limited thereto.

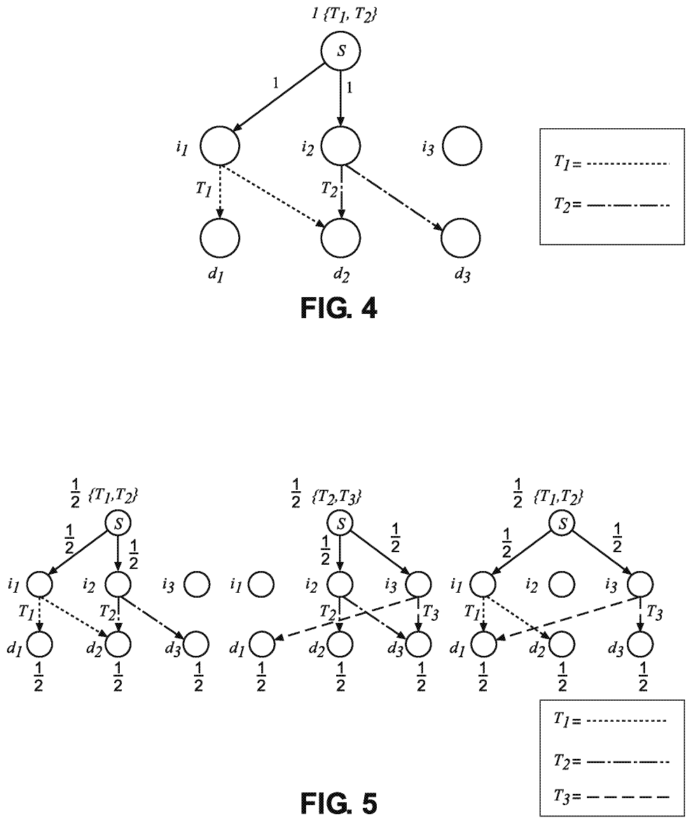

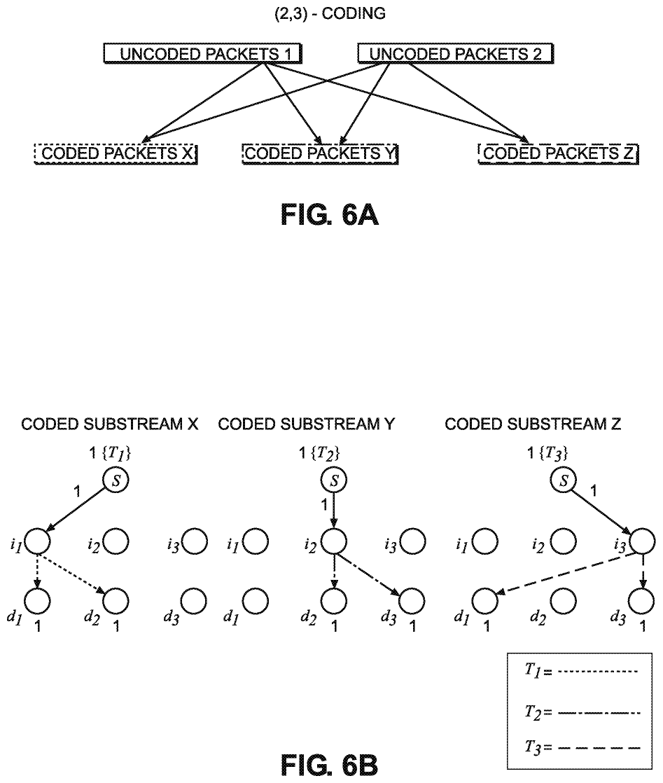

FIG. 3 illustrates an example multicast network according to at least one example embodiment. FIG. 4 illustrates an example single stream multicast tree corresponding to the multicast network of FIG. 3 according to at least one example embodiment. FIG. 5 illustrates example multi-stream multicast trees corresponding to the multicast network of FIG. 3 according to at least one example embodiment. FIGS. 6A and 6B illustrate an example coding of multicast streams and coded multi-stream multicast trees according to some example embodiments.

Referring now to FIG. 3, FIG. 3 is an example multicast network including a source network node S, intermediate network nodes i1 to i3, and/or destination network nodes d1 to d3, according to at least one example embodiment, but the example embodiments are not limited thereto, and for example, may include a greater or lesser number of sources, intermediate, destination network nodes, etc. Further, as illustrated in FIG. 3, a plurality of trees T1 to T3 may be included in the multicast network, but the example embodiments are not limited thereto, and there may be a greater or lesser number of multicast trees included in the network. Additionally, according to some example embodiments, a network controller (not shown), e.g., SDN controller 100, may be connected to the multicast network, but the example embodiments are not limited thereto. In FIGS. 3 to 6B, it is assumed that the maximum transmission rate and/or link capacity possible for each of the links between network nodes is 1 for the sake of simplicity of description and clarity, but the example embodiments are not limited thereto, and the maximum transmission rate and/or link capacity may be any desired value.

As shown in FIG. 3, the source node S may transmit a multicast transmission based on multicast scheduling information received from and/or obtained from a network controller (e.g., SDN controller 100) and/or determined by the source node S itself, to each of the destination nodes d1 to d3 along trees T1, T2, and T3, but the example embodiments are not limited thereto. More specifically, as illustrated in FIG. 3, the source node S may transmit a source transmission to destination node d1 via trees T1 (e.g., node S->node i1->node d1) and/or T3 (e.g., node S->node i3->node d1), may transmit the source transmission to destination node d2 via trees T1 (e.g., node S->node i1->node d2) and/or T2 (e.g., node S->node i2->node d2), and may transmit the source transmission to destination node d3 via trees T2 (e.g., node S->node i2->node d3) and/or T3 (e.g., node S->node i3->node d3), etc., but the example embodiments are not limited thereto.

Referring now to FIG. 4, FIG. 4 illustrates an example of a source node S performing single stream multicasting to destination nodes d1 to d3, but the example embodiments are not limited thereto. In FIG. 4, it is assumed that the source node S is transmitting a multicast stream to the destination nodes d1 to d3, the destination node d1 is subscribed to and/or has selected tree T1 and the destination node d3 is subscribed to tree T2, but the example embodiments are not limited thereto. Additionally, according to at least one example embodiment, the source node S may use either tree T1 or tree T2 of FIG. 3 to transmit the multicast stream to destination node d2, however, the example embodiments are not limited thereto. The source node S may transmit multicast data packets associated with the source multicast transmission, which include a multicast header (e.g., a SRv6 header, etc.) which includes information indicating at least a unique stream identifier (e.g., stream ID) for the multicast transmission, and segmented network path information indicating the segmented network path each of the data packets take to their respective destination node, as well data packet ordering information, etc., such that the multicast data packets arrive in sequence at each of the destination nodes d1 to d3, and therefore no additional processing needs to be performed by either the source node S and/or the destination nodes d1 to d3. However, because the source node transmits the full multicast transmission (e.g., all of the data packets associated with the multicast transmission) along a single network path from the source node to each destination, e.g., transmit all of the data packets for the multicast transmission to node d1 via i1, the maximum transmission rate is limited to 1.

Now referring to FIG. 5, FIG. 5 illustrates an example of a source node S performing multi-stream multicasting (e.g., uncoded multi-stream multicasting, etc.) to the destination nodes d1 to d3, but the example embodiments are not limited thereto. In FIG. 5, in comparison to the single stream multicasting of FIG. 4, the source node S may transmit the source multicast transmission to each of the destination nodes d1 to d3 via multiple multicast streams, or in other words, the source node S may perform multi-stream multicasting, thereby increasing the maximum transmission rate above the maximum transmission rate of 1 achieved using the single stream multicasting of FIG. 4. According to at least one example embodiment, the source node S may divide (e.g., split, etc.) the source multicast transmission into two or more sub-streams and transmit the two or more sub-streams to each of the destination nodes d1 to d3 via different segmented network paths, such that each of the destination nodes d1 to d3 receives all of the data packets associated with the two or more sub-streams in any order, stores the received packets in a buffer, e.g., a re-ordering buffer, a re-ordering memory, etc., and then assembles the data packets into the correct order to recreate the original source transmission, but the example embodiments are not limited thereto. For example, as shown in FIG. 5, the source node S may split the original source multicast transmission into three sub-streams, sub-streams A to C, but the example embodiments are not limited thereto. As shown in FIG. 5, the source node S may simultaneously transmit the sub-stream A at ½ of the maximum transmission rate (e.g., link transmission rate) along tree T1 to destination nodes d1 and d2, e.g., the source node S transmits the sub-stream A data packets to intermediate nodes i1 and i2, and the intermediate nodes i1 and i2 replicate the sub-stream A packets based on the network path information included in the multicast packet headers of the sub-stream A packets, and the intermediate nodes i1 and i2 forward the sub-stream A packets to destination nodes d1 and d2, etc. Simultaneously, the source node S may transmit the packets of sub-stream B at ½ of the maximum transmission rate along tree T2 to destination nodes d2 and d3, or in other words, the source node S may transmit the sub-stream B packets to intermediate nodes i2 and i3, which replicate the sub-stream B packets based on the network path information included in the multicast packet headers of the sub-stream B packets, and the intermediate nodes i2 and i3 forward the sub-stream B packets to the destination nodes d2 and d3, etc. Additionally, the source node S may also transmit the packets of sub-stream C at ½ of the maximum transmission rate along tree T3 to destination nodes d1 and d3, or in other words, the source node S may transmit the sub-stream C data packets to intermediate nodes i1 and i3, and the intermediate nodes i1 and i3 replicate the sub-stream C packets based on the network path information included in the multicast packet headers of the sub-stream C packets, and forward the sub-stream C packets to destination nodes d1 and d3, etc. As can be appreciated by a person of ordinary skill in the art, the link transmission rates between the source node S and each of the intermediate nodes i1 to i3 add up to 1 (e.g., the maximum transmission rate for each network segment), respectively, but the total transmission rate achieved at each of the destination nodes d1 to d3 adds up to 1.5, therefore an increased transmission rate is achieved using the multi-stream multicasting transmission over the single stream multicasting transmission of FIG. 4. However, because the source multicasting transmission is split into a plurality of sub-streams, the source node S and the destination nodes d1 to d3 perform additional processing over the single stream multicasting solution of FIG. 4.

89 Now referring to FIGS. 6A and 6B, according to at least one example embodiment, the source node S may perform coded multi-stream multicasting to each of the destination nodes d1 to d3, but is not limited thereto. The coded multi-stream multicasting may further increase the maximum transmission rate of the multicasting transmission over the single stream multicasting solution of FIG. 4, and the multi-stream multicasting solution of FIG. 5, but may result in additional processing performed by the source node S and the destination nodes d1 to d3, etc. More specifically, the source node S may perform coding, such as streaming (B,C) coding, etc., to the source multicasting transmission in order to compensate for network losses (e.g., dropped packets, lost link connection between network nodes, etc.) and enable the recreation of the original source transmission by the destination nodes d1 to d3 using less than all of the data packets of the source transmission, etc., but the example embodiments are not limited thereto. In other words, the destination nodes d1 to d3 may receive B out of C sub-streams (e.g., packets) of the source multicasting transmission, where B is less than C, and each of the destination nodes d1 to d3 may recreate the missing data packets and, consequently, recreate the source transmission, based on the received data packets. For example, the source node S may split the original source transmission into B uncoded sub-streams, where B is an integer greater than 1, and as shown in FIG. 6A, B may be 2, but the example embodiments are not limited thereto. Next, the source node S may generate C coded packets from the B uncoded packets using a coding scheme, such as Fountain codes or Raptor codes, wherein C is an integer>B, but the example embodiments are not limited thereto. The source node S may then code the C coded packets using a B×C random coding matrix A, where A is random. Because A is random, with high probability, the coding matrix has full rank and therefore all of the packets of the original source transmission may be regenerated by each of the destination nodes d1 to d3 by decoding the B packets (e.g., different packets) out of the C coded packets. In other words, as shown in FIG. 6A, as long as a destination node receives 2 out of the 3 total coded packets, the destination node may regenerate the data of the missing coded packet by decoding the received 2 coded packets, and therefore may regenerate the original source transmission stream, but the example embodiments are not limited thereto.

FIG. 6B illustrates an example of a source node S performing coded multi-stream multicasting to the destination nodes d1 to d3 and assumes that B=2 and C=3 and the maximum transmission rate of each of the links of the network is 1, but the example embodiments are not limited thereto, and other values may be used for B, C, and the maximum transmission rates of each of the network links. According to at least one example embodiment, the source node S may split the original multicast transmission into B uncoded sub-streams. The source node S may then code the B sub-stream packets into C coded sub-stream packets, where C is >B, using a coding scheme, such as Fountain codes and/or Raptor codes, etc., but the example embodiments are not limited thereto. Additionally, the source node S may include a stream ID indicating the source transmission ID, a sub-stream ID, and the segment network path information, into the header of each packet of the coded sub-streams. Next, the source node S transmits the packets of each coded sub-stream to B of the destination nodes, and for example, the source node S may transmit the packets of coded sub-stream X to destination nodes d1 and d2 via tree T1, may transmit the packets of coded sub-stream Y to destination nodes d2 and d3 via tree T2, and may transmit the packets of coded sub-stream Z to destination nodes d1 and d3 via tree T3, but the example embodiments are not limited thereto. Because the source node S is only transmitting a single coded sub-stream along each of the links between node S and the intermediate nodes i1 to i3 at the full maximum transmission rate of 1, in contrast to the multi-stream multicasting example scheme of FIG. 5, each destination node d1 to d3 realizes a maximum multicast transmission rate of 2, but the example embodiments are not limited thereto. Additionally, as seen in FIG. 6B, each of the destination nodes only receives a subset of the C coded sub-streams transmitted by source node S. For example, destination node d1 receives the packets of coded sub-streams X and Z, destination node d2 receives the packets of coded sub-streams X and Y, and destination node d3 receives the packets of coded sub-streams Z and X, etc. However, because the packets received by the destination nodes d1 to d3 are coded and are only a subset of the C coded sub-streams, the destination nodes d1 to d3 must perform additional processing to decode the N received coded sub-streams, where N=B, and must regenerate the missing packets from the un-received C—N sub-stream(s), e.g., the missing 1 sub-stream, in order to regenerate the original source multicast transmission.

Referring now to FIG. 7, FIG. 7 is a flowchart illustrating a method of determining multi-stream scheduling information by a network device according to at least one example embodiment. According to at least one example embodiment, the network device performing the operations of FIG. 7 may be a network controller, such as SDN controller 100, etc., and/or may be a source host device, such as source host device S, etc., but the example embodiments are not limited thereto, and the network device may be any network device connected to and/or included in a multicast group, etc. In operation S7010, the network device may obtain (e.g., receive, determine, etc.) at least one of topology information (e.g., network topology information, network architecture, link connection information, etc.), link capacity information (e.g., the maximum link transmission rate, current link transmission rate, etc.), tree subscription information (e.g., information indicating a tree of a plurality of trees associated with the network topology and/or multicast network to which a host device subscribes, etc.), and/or multicast group information (e.g., identification of the desired multicast group to which the source multicast transmission will be transmitted, etc.), etc., from at least one host device of a desired multicast group, but the example embodiments are not limited thereto, and for example may include other information, such as QoS settings for the desired multicast transmission, information regarding the size of a desired multicast transmission, etc. For example, the network device may obtain the topology information, link capacity information, and/or multicast group information, etc., as part of a multi-stream multicasting session request from a source host device S, etc., but the example embodiments are not limited thereto, and for example, the network device may also receive the topology information, link capacity information, and/or multicast group information, etc., from the destination source devices, e.g., d1 to d3, etc., one or more of the intermediate network nodes i1 to i3, etc., the core network, a network operator, a network administrator, etc.

In operation S7020, the network device may determine multi-stream scheduling information and/or coding parameters based on the obtained information, but is not limited thereto. For example, the network device may determine multi-stream scheduling information for the desired multicast group based on the topology information, tree subscription information, link capacity information, etc., obtained from and/or associated with one or more of the host devices and/or network nodes associated with the multicast group, etc., but the example embodiments are not limited thereto. According to at least one example embodiment, the multi-stream scheduling information may include information related to a determined and/or selected multicast group session tree associated with the multicast request and/or the desired multicast group, the multicast group session tree including segmented network paths from the source node S to each of the destination nodes, e.g., d1 to d3, of the desired multicast group, etc. Additionally, the multi-stream scheduling information may include information related to multicast transmission rates for each segmented network path of the multicast group session tree, etc. Moreover, the multi-stream scheduling information may also include coding parameter information, such as information related to the type of multi-stream multicast transmission to use (e.g., single stream multicast transmission, multi-stream multicast transmission, coded multi-stream multicast transmission, etc.), the number of sub-streams for the desired multi-stream multicast transmission, the type of coding to encode the sub-streams with, the size of each data packet for the desired multi-stream multicast transmission, etc., but the example embodiments are not limited thereto.

According to at least one example embodiment, if the selected multicast transmission type is determined to be an uncoded multicast transmission (e.g., an uncoded single stream multicast transmission or an uncoded multi-stream multicast transmission, etc.), which may be determined based on the QoS settings associated with the multicast group and/or multicast transmission, may be determined based on network operator settings, host device settings, the network request, etc., the network device may determine an uncoded multicast group session tree to transmit each stream at a desired multicast rate (e.g., an increased, improved, optimized, and/or maximized multicast transmission rate) by solving the following linear programming problem:

$$UNC : min θ \\ {\sum }_{j : {T}_{j} ∋ d} {y}_{ij} \geq 1 ∀ d ∀ i \\ ( \frac{1}{k} ) {\sum }_{j : {T}_{j} ∋ e} {\sum }_{i} {y}_{ij} \leq c ( e ) θ ∀ e \\ {y}_{ij} ∈ \{ 0 , 1 \} ∀ j , i \qquad [ Equation set 1 ]$$

Wherein d corresponds to each destination node to be reached; i is an individual stream; T is the set of all applicable network trees; j is an individual tree of the plurality of network trees T; c (e) is the link capacity of a network link e (e.g., a network edge of the obtained topology of the network, etc.); k is the number of desired streams (e.g., if the selected multicast transmission protocol is single stream multicasting, then k=1, and if the selected multicast transmission protocol is multi-stream multicasting or coded multi-stream multicasting, k>1, etc.); λ=the maximum rate that may be transmitted out of the source network node to all destination network nodes without violating link capacities; and yᵢⱼ=1, if the stream i is assigned to tree j, and yᵢⱼ=0, if the stream i is not assigned to tree j.

Solving Equation set 1 provides a multicast group session tree (and/or a set of multicast group session trees) for the uncoded multicast transmission, and also sets a desired transmission rate for each stream that increases, improves, optimizes, and/or maximizes for the multicast group session transmission. More specifically, the first equation of Equation set 1 ensures that each destination receives every stream, and the second equation Equation set 1 counts the number of streams that traverse link e and correspond to the link capacity constraints, etc.

According to at least one example embodiment, if the selected multicast transmission type is determined to be a coded multicast transmission (e.g., a coded multi-stream multicast transmission, etc.), which may also be determined based on the QoS settings associated with the multicast group and/or multicast transmission, may be determined based on network operator settings, host device settings, the network request, etc., the network device may determine a coded multicast group session tree to transmit each stream at a desired multicast rate (e.g., an increased, improved, optimized, and/or maximized multicast transmission rate) by solving the following linear programming problem:

$$COD : min δ \\ {\sum }_{j : {T}_{j} ∋ d} {z}_{j} \geq 1 ∀ d \\ {\sum }_{j : {T}_{j} ∋ e} {z}_{j} \leq c ( e ) δ ∀ e \\ {z}_{j} \geq 0 ∀ j \qquad [ Equation set 2 ]$$

Wherein w=the maximum achievable multicast rate; wⱼ=the amount of transmission flow sent on tree j; δ=1/w; and zⱼ=wⱼ/w.

Solving Equation set 2 provides a multicast group session tree (and/or a set of multicast group session trees) for a coded multicast transmission, and also sets a desired transmission rate for each stream that increases, improves, optimizes, and/or maximizes for the multicast group session transmission. More specifically, the first equation of Equation set 2 ensures that a flow of w reaches every destination node, and the second equation of Equation set 2 enforces the link capacity bound, etc. Additionally, because a coded multicast transmission is used, not every individual packet and/or stream (e.g., sub-stream) is received by every destination node (e.g., not every packet and/or sub-stream is transmitted by the source node to each destination node), but instead, Equation set 2 ensures that enough packets/sub-streams reach each destination node (e.g., B packets/sub-streams out of the C coded packets/coded sub-streams) such that each destination node is capable of recreating and/or regenerating the original source transmission from the received, etc.

Additionally, the solution of Equation set 2 may be used to compute the coding parameters, B and C, by inputting the solution of Equation set 2 into the following algorithm:

[Algorithm 1]
FIG. 8: Coding Parameters from LP Solution

```
1: Input: LP optimal solution value of δ* and
    the optimal solution z* to the linear program
    COD
2: for Each tree j do
3:  $Compute {F}_{j} = ⌊ \frac{{z}_{j}^{*}}{βδ \text{?}} ⌋$
4: Compute the integer achieved rate
            $R = {min}_{d} {\sum }_{j \text{?} {T}_{j} ∋ d} {F}_{j}$
5: end for
6: Output: Use an (R, Σⱼ Fⱼ) streaming code
    for the coded multi-stream multicast scheme
    each with rate β

[symbol]

[symbol]

indicates data missing or illegible when filed
```

Wherein z*ⱼ=the optimal fraction of transmission flow sent on tree Tⱼ; z*ⱼ/δ*=the actual transmission flow sent on tree Tⱼ; β=the transmission rate of each stream; C=R=the total number of coded streams; and B=ΣⱼFⱼ=the minimum number of streams.

According to at least one example embodiment, if the selected multicast transmission type is determined to be an uncoded multicast multiple multicast group transmission (e.g., an uncoded multicast transmission transmitted to multiple multicast groups, etc.), which may be determined based on the QoS settings associated with the multicast group and/or multicast transmission, may be determined based on network operator settings, host device settings, the network request, etc., the network device may determine an uncoded multicast group session tree to transmit each stream at a desired multicast rate (e.g., an increased, improved, optimized, and/or maximized multicast transmission rate) by solving the following linear programming problem:

$$min δ \\ {\sum }_{j : {T}_{j} ∋ d} {w}_{j}^{g} \geq 1 ∀ d ∈ {D}^{g} ∀ g \\ {\sum }_{g} {r}^{g} {\sum }_{j : {T}_{i} ∋ e} {w}_{j}^{g} \leq c ( e ) δ ∀ e \\ {w}_{j}^{g} ∈ \{ 0 , 1 \} ∀ j , g \qquad [ Equation set 3 ]$$

Wherein G=the entire set of multicast groups g; D=the set of destination nodes for the multicast transmission; s^{g}=the source node for the group g, D^{g}=the set of destination nodes for the group g; r^{g}=the desired rate for the group g; and w^{g}ⱼ is set to 1 if the multicast group g uses tree j.

Solving Equation set 3 provides a multicast group session tree (and/or a set of multicast group session trees) for an uncoded multicast multiple multicast group transmission multicast transmission, and also sets a desired transmission rate for each stream that increases, improves, optimizes, and/or maximizes for the multiple multicast group session transmission. More specifically, the first equation of Equation set 3 ensures that a rate of re is transmitted for group g, and the second equation of Equation set 3 ensures that the link utilization does not exceed δ, etc. Additionally, Equation set 3 may be extended for coded multi-stream multiple multicast group transmission by obtaining approximate solutions for the uncoded multi-group multicasting equations of Equation set 3.

In operation S7030, once the network device has determined the multi-stream scheduling information and/or coding parameters, the network device transmits at least part of the multi-stream scheduling information and/or coding parameters to the source host device and/or one or more destination destination host devices, but is not limited thereto.

Referring now to FIG. 8, is a flowchart illustrating a method of operating a source host device according to at least one example embodiment. According to at least one example embodiment, the source host device of FIG. 8 may correspond to source host device S of FIGS. 1 and 3 to 6B, etc., but the example embodiments are not limited thereto. In operation S8010, the source host device may transmit a multi-stream multicasting session request to a network controller, such as SDN controller 100, etc., but the example embodiments are not limited thereto. For example, according to some example embodiments, the multicast network may omit the network controller and the source host device may internally handle the request, etc. The multi-stream multicasting session request may include at least one of topology information, link capacity information, and/or multicast group information associated with a source multicast transmission, but is not limited thereto. For example, the request may further include information such as QoS settings for the desired multicast transmission, information regarding the size of a desired multicast transmission, etc.

In operation S8020, the source host device may receive multi-stream scheduling information and/or coding parameters from the network controller, etc., but the example embodiments are not limited thereto. For example, according to some example embodiments, the source host device may determine the multi-stream scheduling information and/or the coding parameters itself, instead of receiving such information from a network controller, but the example embodiments are not limited thereto. According to at least one example embodiment, the multi-stream scheduling information may include information related to a multicast group session tree associated with the multicast request and/or the desired multicast group(s), the multicast group session tree including segmented network paths from a source node to each destination node of the desired multicast group(s), etc. Additionally, the multi-stream scheduling information may include information related to multicast transmission rates for each segmented network path of the multicast group session tree, etc. Moreover, the multi-stream scheduling information may also include coding parameter information, such as information related to the type of multi-stream multicast transmission to use (e.g., single stream multicast transmission, multi-stream multicast transmission, coded multi-stream multicast transmission, etc.), the number of sub-streams for the desired multi-stream multicast transmission (e.g., the B value for uncoded multi-stream multicast transmissions, B and/or C values for coded multi-stream multicast transmissions, etc.), the type of coding to encode the sub-streams with, the size of each data packet for the desired multi-stream multicast transmission, etc., but the example embodiments are not limited thereto.

In operation S8030, the source host device may perform processing on the source multicast transmission based on the multi-stream scheduling information and/or coding parameters. For example, the source host device may encode each packet header of each data packet of the source multicast transmission with the associated segmented network path to the desired destination host device based on the multi-stream scheduling information, the source host device may split the source multicast transmission into a plurality of multicast sub-streams based on the coding parameters, the source host device may code each of the multicast sub-streams based on the coding parameters, etc., but the example embodiments are not limited thereto.

In operation S8040, the source host device may transmit the multi-stream multicast transmission(s) to the destination host devices using the multicast group session tree based on the multi-stream scheduling information. Additionally, in response to receiving the multi-stream multicast transmissions from the source host device, each of the destination host devices may regenerate the original source multicast transmission based on the multi-stream scheduling information and/or coding parameters associated with the desired multicast group and/or desired multicast session. For example, the destination source devices may re-order the received uncoded sub-streams to regenerate the original source multicast transmission, the destination source devices may decode the received coded sub-streams and may regenerate missing sub-streams based on the received decoded sub-streams and the coding parameters, etc., but the example embodiments are not limited thereto.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1-20. (canceled)

21. A source host device comprising:
a memory storing computer readable instructions; and
processing circuitry configured to execute the computer readable instructions to cause the device to,
obtain multicast scheduling information from a software defined network (SDN) controller, the multicast scheduling information including information related to a plurality of multicast trees associated with a network, each multicast tree of the plurality of multicast trees including at least one network node, and
transmit a plurality of multi-stream multicast transmissions associated with a source multicast stream transmission to a plurality of destination host devices using a multicast group session tree based on the multicast scheduling information, the multicast group session tree associated with a desired multicast group, the multicast group including the source host device and the plurality of destination host devices.

22. The device of claim 21, wherein
the multicast scheduling information includes transmission bandwidth information associated with each network node of the plurality of multicast trees, and tree subscription information indicating a single multicast tree of the plurality of multicast trees to which each destination host device is subscribed;
the multicast group session tree includes a plurality of segmented network paths from the source host device to each destination host device of the plurality of destination host devices; and
each of the plurality of segmented network paths are determined based on the transmission bandwidth information and the tree subscription information.

23. The device of claim 22, wherein
the multicast scheduling information includes the information on the multicast group session tree, the multicast group session tree determined from the plurality of multicast trees by the SDN controller based on the multicast scheduling information.

24. The device of claim 22, wherein the device is further caused to:
determine the multicast group session tree from the plurality of multicast trees based on the multicast scheduling information.

25. The device of claim 21, wherein the device is further caused to transmit the plurality of multi-stream multicast transmissions by:
dividing the source multicast stream transmission into a first number of multi-stream multicast transmissions based on the multicast scheduling information, where the first number is greater than 1.

26. The device of claim 25, wherein the device is further caused to transmit the plurality of multi-stream multicast transmissions by:
transmitting each of the first number of multi-stream multicast transmissions to each of the plurality of destination host devices using different segmented network paths of the multicast group session tree to each of the plurality of destination host devices.

27. The device of claim 26, wherein the transmitting each of the first number of multi-stream multicast transmissions to each of the plurality of destination host devices causes each of the destination host devices to:
receive the first number of multi-stream multicast transmissions from the source host device; and
restore the source multicast stream transmission from the received first number of multi-stream multicast transmissions.

28. The device of claim 25, wherein the device is further caused to transmit the plurality of multi-stream multicast transmissions by:
coding the first number of multi-stream multicast transmissions into a second number of sub-stream transmissions using coding parameters, where the second number is bigger than the first number; and
transmitting any third number of different sub-stream transmissions of the second number of sub-stream transmissions to each of the plurality of destination host devices using different segmented network paths, wherein the third number is bigger than or equal to the first number and the third number is smaller than or equal to the second number.

29. The device of claim 28, wherein the device is further caused to:
receive the coding parameters from the SDN controller, the coding parameters including information indicating whether to use Fountain code coding or Raptor code coding, the value of the first number, and the value of the second number; and
perform the coding of the first number of multi-stream multicast transmissions into the second number of sub-stream transmissions based on the received coding parameters.

30. The device of claim 26, wherein the device is further caused to:
determine the coding parameters, the determining including determining whether to use using Fountain code coding or Raptor code coding, determining the value of the first number, and determining the value of the second number; and
perform the coding of the second number of multi-stream multicast transmissions into the third number of sub-stream transmissions based on the determined coding parameters.

31. The device of claim 28, wherein the transmitting the third number of different sub-stream transmissions to each of the plurality of destination host devices causes each of the destination host devices to:
receive at least the first number of sub-streams;
decode the first number of multi-stream multicast transmissions based on coding parameter information included in a packet header of the third number of sub-stream transmissions; and
restore the source multicast stream transmission from the decoded first number of multi-stream multicast transmission.

32. A software defined network (SDN) controller device, the device comprising:
a memory storing computer readable instructions; and
processing circuitry configured to execute the computer readable instructions to cause the device to,
obtain topology information, link capacity information, and multicast group information related to a plurality of host devices of a network,
determine multicast scheduling information associated with at least one multicast group based on the topology information, the link capacity information, and the multicast group information, the multicast scheduling information including,
information related to a plurality of multicast trees associated with the network, each multicast tree of the plurality of multicast trees including at least one network node, transmission bandwidth information associated with each network node of the plurality of multicast trees, and
tree subscription information indicating a single multicast tree of the plurality of multicast trees to which each host device is subscribed, and
transmit at least a part of the multicast scheduling information to each of the host devices of the network.

33. The SDN controller device of claim 32, wherein the device is further caused to, for each multicast tree of the plurality of multicast trees:
determine a plurality of segmented network paths between each host device of the multicast tree based on the transmission bandwidth information and the tree subscription information; and
configure each network node included in the multicast tree based on the determined plurality of segmented network paths.

34. The SDN controller device of claim 32, wherein the device is further caused to:
receive a multi-stream multicast transmission request from a source host device, the multi-stream request including information related to a source multicast stream transmission and the multicast group information; and
determine the multicast scheduling information in response to the multi-stream multicast transmission request, the determining including determining a multicast group session tree from the plurality of multicast trees based on the information related to the source multicast stream transmission and the information indicating the desired multicast group.

35. The SDN controller device of claim 34, wherein the device is further caused to:
determine a first number indicating a number of multi-stream multicast transmissions to divide the source multicast stream transmission into, where the first number is greater than 1.

36. The SDN controller device of claim 34, wherein the device is further caused to:
determine coding parameters for the source multicast stream transmission in response to the multi-stream multicast transmission request, the determining the coding parameters including,
determine whether to use using Fountain code coding or Raptor code coding for the coding of the multi-stream multicast transmissions; and
determine a second number indicating a number of sub-stream transmission to divide the first number of multi-stream multicast transmission into, wherein the first number is bigger than 1, the second number is bigger than 1, and the second number is bigger than the first number.

37. A method of operating a source host device comprising:
obtaining multicast scheduling information from a software defined network (SDN) controller, the multicast scheduling information including information related to a plurality of multicast trees associated with a network, each multicast tree of the plurality of multicast trees including at least one network node; and
transmitting a plurality of multi-stream multicast transmissions associated with a source multicast stream transmission to a plurality of destination host devices using a multicast group session tree based on the multicast scheduling information, the multicast group session tree associated with a desired multicast group, the multicast group including the source host device and the plurality of destination host devices.

38. The method of claim 37, wherein
the multicast scheduling information includes transmission bandwidth information associated with each network node of the plurality of multicast trees, and tree subscription information indicating a single multicast tree of the plurality of multicast trees to which each destination host device is subscribed;
the multicast group session tree includes a plurality of segmented network paths from the source host device to each destination host device of the plurality of destination host devices; and
each of the plurality of segmented network paths are determined based on the transmission bandwidth information and the tree subscription information.

39. The method of claim 38, wherein the multicast scheduling information includes the information on the multicast group session tree, the multicast group session tree determined from the plurality of multicast trees by the SDN controller based on the multicast scheduling information.

40. The method of claim 38, further comprising:
determining the multicast group session tree from the plurality of multicast trees based on the multicast scheduling information.
